(19) United States
(12) Patent Application Publication
(10) Pub. No.: US 2018/0325087 A1
(43) Pub. Date: Nov. 15, 2018

(54) HORSE SHOEING, ESPECIALLY FOR RACEHORSES

(71) Applicant: WINNER AG, Chur (CH)

(72) Inventors: Martin Zindel, Landquart (CH); Christian Lampert, Jenins (CH)

(21) Appl. No.: 15/591,888

(22) Filed: May 10, 2017

(51) Int. Cl. A01L 5/00; A01L 1/02; B29C 45/14; B29C 45/73; B29C 45/72; B29C 45/00; B29C 45/26

(52) U.S. Cl. CPC A01L 5/00; A01L 1/02; B29C 45/14631; B29C 45/14065; B29K 2069/00; B29C 45/7207; B29C 45/0055; B29C 45/2628; B29C 45/73

(57) ABSTRACT

There is shown and described a shoeing for horses, in particular for racehorses being used in competition, constructed from a core made of fiber-reinforced plastic material which is surrounded by a functional layer made of plastic.

According to the invention it is provided that the core is formed substantially from a fiber-reinforced thermoplastic polymer material (i.e. a fiber-reinforced thermoplastic) and the functional layer is formed substantially from a thermoplastic polycarbonate material or a fiber-reinforced thermoplastic polycarbonate material (i.e. a thermoplastic or a fiber-reinforced thermoplastic).

Furthermore there is shown and described a thermoplastic injection molding method for producing the shoeing.

### TECHNICAL FIELD OF THE INVENTION

The invention relates to a shoeing for horses substantially containing a core made of fiber-reinforced plastic material and a functional layer, made of plastic material or fiber-reinforced plastic material, surrounding the core. The shoeing according to the invention is suitable for sports horses, in particular for racehorses being used in competition.

### BACKGROUND OF THE INVENTION

The shoeings for racehorses used most frequently have in the past consisted normally of aluminum. This type of shoeing is relatively light (approx. 127 grams), but very rigid and hard. The friction of the aluminum shoe is low. An aluminum shoe remains for approximately 5 weeks, and thereafter the horse has to be re-shod. This is in particular also the case because the hoof grows back.

Patent application US 2010/0276163 A1 proposes alternatively, inter alia, a shoeing made of fiber-reinforced plastic which protects the horse's hoof against friction and is relatively light. In one variant, a plastic bottom layer is additionally proposed in the named patent application, whereby the fiber composite material is intended to be protected against erosion, while simultaneously the sticking friction on hard subsoil, such as e.g. concrete or asphalt, is intended to be increased, and the impact is intended to be cushioned.

In patent application WO 87/06097 A1, a metal core with an elastic rubber coat is presented which, as much as possible, is intended to have the properties of a natural hoof sole. In documents GB 2 222 757 A, U.S. Pat. No. 4,972,909 A and WO 2004/023871 A1, shoeings with a fiber-reinforced plastic core and plastic coating of the most varied combinations of materials are presented. Frequently, polyurethanes are used. In the examples listed therein, this also concerns in particular achieving high shock absorption and/or permitting a specific natural mobility of the hoof in order to guard against problems of the musculoskeletal system.

In many equestrian sports, quite particularly racing, durable shoeings are a basic prerequisite for being able to take part in the sport at a competitive level; this also includes regular and intensive training. In addition to the durability or stability of shoeing, in sport particularly the performance of the animal is of interest. Shoes available today are not ideal, in particular not for horseracing, as for one they are not durable enough and/or disadvantageously influence the performance of the horse, for example by too great a weight, unfavorable surface adhesion, friction properties and/or cushioning properties.

In patent application CH710762 (A2), a shoeing for racehorses is described which consists of a fiber-reinforced thermoset material core (for example carbon-fiber-reinforced epoxy resin) in the examples relevant to the invention, which core is coated with a top layer of plastic, e.g. a top layer produced from thermoset or thermoplastic polyurethane resin. These shoes are very light and should have a high stability and durability because of the fiber-reinforced thermoset material core. It has been possible to show that the actual racing performance of a horse increases because of the reduced weight of a shoeing reinforced with carbon fibers. However, it has been proven that the shoeings frequently experienced cracks unexpectedly after a short time in use, whereby the shoeing became unusable and had to be replaced early. Additionally, depending on the training and ground conditions it has been proven that the wear was not ideal, which can shorten the life of the shoeing and impair its grip properties.

### ADVANTAGES OF THE INVENTION

Therefore, the present invention provides a shoeing for sports horses, in particular racehorses, with which the horses can achieve high running speeds. Furthermore, the present invention overcomes the disadvantages named at the outset and to provide a shoeing which has a low friction at a low weight in order to be able to be used for as long as possible, in particular at least for four weeks, or can be left on the hoof. Furthermore, the shoeing is intended to provide good support, prevent the hoof from sinking into soft ground as much as possible and remain as free from soil material as possible. Additionally, the risk of cracks of the shoeing when in use (training and races) is intended to be as low as possible. The present invention provides a shoeing which can be produced as simply, in terms of manufacturing, and cost-favorably as possible.

### DESCRIPTION

These and other advantages are achieved by the features of the independent claims. Developments and/or advantageous embodiments of the invention are the subject matter of the dependent claims.

This invention meets the aforementioned requirements by providing a shoeing for horses, in particular for racehorses being used in competition, constructed from a core made of fiber-reinforced plastic material which is surrounded by a functional layer made of plastic, wherein the core is formed substantially from a fiber-reinforced thermoplastic polymer material (i.e. a fiber-reinforced thermoplastic) and the functional layer is formed substantially from a thermoplastic polymer material (i.e. a thermoplastic or a fiber-reinforced thermoplastic). The core is substantially coated with or surrounded by the functional layer.

The thermoplastic polymer material of the functional layer may be selected from the group of polycarbonates (PC). Advantageously, this is also fiber-reinforced. The abrasion resistance of this material has proven particularly favorable for shoeings, particularly for shoeings for racehorses.

The thermoplastic polymer material of the core or of the matrix of the fiber composite core can be selected from the group of polycarbonates (PC). It is particularly advantageous if the fiber is present as a mesh which is embedded into the polymer matrix. Stability, elasticity and rigidity of the material prove particularly favorable for shoeings, particularly for shoeings for racehorses.

The use of thermoplastic polycarbonate (PC) for core or core matrix and functional layer has proven particularly advantageous. This combination of materials produces particularly good bonding conditions between core and functional layer. Moreover, the combination of materials has particularly advantageous properties for shoeings, in particular with regard to stability, elasticity, rigidity and abrasion resistance. A further advantage of the named combination of materials comes from the additional possibility of thermally deforming the shoeing in order to achieve a better fit.

With regard to the physical aspect, the shoeing according to the present invention provides the basic advantage of reduced weight. Alongside this, the shoeing according to the invention additionally provides advantages from a medical and application technology point of view. The advantages compared to conventional shoeings, such as e.g. iron and aluminum, are better cushioning, which leads to less stress on the tendons and joints, better elasticity for the proper motion of the hoof, the consequence of which is better expenditure of energy, and less weight, and thus less inertia while retaining good slip resistance and slide resistance. Overall, this leads to an optimized sequence of motions of the racehorse when galloping. Further advantages compared to other shoeings with a fiber composite core are an improved connection between core and functional layer, which hold together even under heavy strain (in competition conditions).

The core of the shoeing may be coated at least on the bearing surface and all edges of the shoe. Quite particularly, the core, may be substantially coated on all sides, i.e. on the bearing surface, the hoof side and the lateral surfaces connecting the bearing surface and hoof surface, on both inside and outside.

The fibers reinforcing the core can for example be chosen from the group consisting of carbon fibers, polymer fibers such as e.g. aramid fibers (i.e. Kevlar fibers), glass fibers or combinations thereof.

The fiber reinforcement of the core expediently contains essentially long fibers or quasi-continuous fibers. Long fibers are in particular fibers of a length of at least 20 mm, that may be at least 50 mm, or longer.

The fibers reinforcing the core can be arranged in one or more layers, e.g. by the fibers of a layer forming a meshing, a knitted fabric or a mesh. A meshing, a knitted fabric or a mesh can e.g. be produced from long fibers or continuous fibers. If there are several layers present, the fiber alignment may be different in the different layers. The fibers of each layers may be present as a mesh. In one embodiment, the core contains, e.g. in alternating sequence, mesh layers of carbon fibers and mesh layers of glass fibers, which are embedded in a thermoplastic matrix. The core may comprise several layers of continuous reinforcement fibers which are embedded in a matrix of technical thermoplastics.

The thermoplastic polymer material of the functional layer can be fiber-reinforced, e.g. with plastic fibers, carbon fibers, glass fibers and/or aramid fibers, or with carbon fibers and/or glass fibers.

To reinforce the fibers of the functional layer, expediently short fibers can be used which may be blended with the thermoplastic polymer material of the functional layer. Short fibers may be fibers with a length of less than 20 mm, less than 10 mm, or of a length between 0.1 and 1 mm, including e.g. also whiskers.

The thermoplastic polymer material for the functional layer can advantageously be selected from the group consisting of fiber-reinforced polycarbonate, in particular glass-fiber reinforced polycarbonate, having a 10 wt.-% to 50 wt.-% fiber-reinforced polycarbonate, a 20 wt.-% to 40 wt.-% fiber-reinforced polycarbonate, or a 25 wt.-% to 35 wt.-% fiber-reinforced polycarbonate, e.g. with PC-GF30.

The material of the functional layer can be applied to the core e.g. by injection molding. An injection mold can be used to shape the shoe mold, wherein the core is inserted into the mold in advance. Injection molding may be used as the production method. In each case, the aim is to produce a permanent connection between core and functional layer of the shoeing.

The core is expediently produced from a plate made of plastic fiber composite or made of fiber-reinforced thermoplastic polymer material. The plate may be cut by water jet cutting.

Optionally, an abrasion protection can be integrated in the shoeing, which protection is comprised of a material which is more abrasion-resistant than the functional layer. The abrasion protection can be formed substantially from a metal strip, e.g. a steel strip, or made of tool steel.

Advantageously, the abrasion protection is embedded in the core, for example by the core having recesses or continuous holes in the front region of the shoeing, which recesses or holes serve to equip the core with abrasion protection on the side of the bearing surfaces. For this purpose, the abrasion protection has e.g. protuberances which are designed such that the abrasion protection can be introduced (e.g. inserted) into the recesses or continuous holes of the core by means of the protuberances and can optionally be fixed as a result. The abrasion protection integrated in the shoeing is substantially distant from the core, arranged on the side of the bearing surface of the core.

The shoeing has substantially the form of a U-shaped curved bar which is optionally provided with holes for horseshoe nails.

The shoeing according to the invention may be carried out for fixing to the horse's hoof by means of nails. The shoeing optionally has a groove in the middle of the base, in which rectangular holes for nails for fixing to the horse's hoof are or can be made. This type of embodiment serves likewise to provide good grip of the ground or acts as slide protection. However, the fixing on the horse's hoof can also be carried out alternatively by adhesion.

Furthermore, a production method for producing a shoeing is disclosed here. The shoeing can be produced e.g. by means of extrusion methods and by means of injection molding methods (thermoplastic injection molding methods).

The shoeing may be produced by a thermoplastic polymer material (i.e. e.g. polycarbonate or fiber-reinforced polycarbonate) being melted on, a plastic fiber composite core (i.e. e.g. a core made of fiber-reinforced thermoplastic material) being inserted into a mold and the plastic fiber composite core with the melted-on thermoplastic polymer material being surrounded or extrusion-coated. After curing the thermoplastic polymer material this forms a functional layer which substantially surrounds the core.

A mixture of melted-on thermoplastic polymer material and fibers, in particular short fibers, can be applied to the core as a functional layer via an extruding or injection-molding system.

A thermoplastic polycarbonate may be used for the functional layer, which thermoplastic polycarbonate can be melted-on, e.g. at a temperature of from 260° C. to 340° C., or at a temperature of from 280° C. to 320° C.

The polymer material for the functional layer is expediently injected into the mold with a specific injection pressure of from 800 bar to 1400 bar. This pressure is favorable in particular in the processing of thermoplastic polycarbonate.

The mold may be pre-tempered, e.g. at 80° C. to 130° C., or at 80° C. to 120° C., before the melted polymer material is injected. The named temperatures for pre-tempering are favorable in particular in the processing of thermoplastic polycarbonate.

Furthermore, the polymer material for the functional layer may be pre-dried before being melted on, e.g. at 100° C. to 130° C., or at 100° C. to 120° C. The named temperatures are favorable in particular for pre-drying thermoplastic polycarbonate. Pre-drying is normally for between 2 to 8 hours.

The casting mold or injection mold can be equipped with support structures, in particular support pins, by means of which the plastic fiber composite core is supported spaced apart from the mold surfaces and/or positioned stationary within the mold.

Expediently, at least four support structures (e.g. as support pins), such as at least 6 support structures, or at least 10 support structures, are present to support the plastic fiber composite core. These are arranged in the mold and may be uniformly distributed over the curved longitudinal extension of the U-shaped mold, in order to support a similarly shaped U-shaped core to be inserted as uniformly as possible. These support structures can simultaneously be those pre-shaped parts which are used to make nail holes.

Optionally, the mold is equipped with mold inserts or inserts are present in the mold by means of which material recesses and/or continuous hole notches can be achieved in the shoeing.

Advantageously, the support structures or support pins and/or mold inserts are made of metal, e.g. of steel, in particular made of tool steel. In order that the support structures or support pins and/or mold inserts do not remain in the shoeing when the finished shoeing is ejected, the support structures or support pins and/or mold inserts are fixed in the mold.

If the plastic fiber composite core is equipped with an abrasion protection, in the mold this can serve as a further support structure for the plastic fiber composite core. However, the abrasion protection is not fixed or anchored in the mold, as it is intended to be pushed out of the mold with the finished shoeing. Abrasion protection and plastic fiber composite core are substantially embedded simultaneously during the injection-molding process in the melted-on polymer material and thereby integrated in the shoeing.

The production method is optionally comprises that, after surrounding or extrusion-coating the core, the shoeing is cooled for curing, and after curing, the curvature of the shoeing at temperature above room temperature is adjusted to a predetermined fit by mechanical deforming, such as e.g. by pushing or pulling. To prepare the shoeing for mechanical working, this is heated to a temperature above room temperature in which the material or matrix material of the core and of the functional layer is softened and is plastically deformed accompanied by force or pressure and pulling. The named increased temperature is expediently in a range over the temperatures occurring during use of the shoeing, e.g. at over 100° C., such as in the range of from 120° C. to 160° C., in the range of from 130° C. to 150° C., or at approx. 140° C. In particular polycarbonates, in particular a fiber-reinforced polycarbonate core as described above and a fiber-reinforced polycarbonate functional layer as described above, can, at these temperatures, be mechanically deformed into a mass which is sufficient for the purpose of the application.

Furthermore, the result of this is also a method for shoeing a horse's hoof in which the shoeing is adapted to the hoof shape of a horse's hoof to be shod, at a temperature which is above room temperature (expediently in a range above 100° C., in particular e.g. in the range of from 120° C. to 160° C., or in the range of from 130° C. to 150° C.) by mechanical working or mechanical deformation, such as e.g. by pushing or pulling.

The advantageous embodiment variants listed below lead, on their own or in combination, to further improvements of the subject matter according to the invention.

### DESCRIPTION OF THE FIGURES

Further advantages and features of the shoeing according to the invention result from the following description of an embodiment of the invention with reference to schematic representations. Named features can be realized in any combinations, insofar as they are not mutually exclusive. In schematic representation and not to scale:

FIGS. 1a, 1b and 1c show views of a shoeing according to the invention for the front foot, wherein FIG. 1a is a bottom view of the shoeing, FIG. 1b is a hoof-side view of the shoeing, and FIG. 1c is a side view;

FIGS. 2a, 2b, and 2c show views of a shoeing according to the invention for the back foot, wherein FIG. 2a is a bottom view of the shoeing, FIG. 2b is a hoof-side view of the shoeing, and FIG. 2c is a side view;

FIG. 3a shows a top view and FIG. 3b shows a side view of a core (without functional layer) of a shoeing according to the invention for the front foot;

FIG. 4a shows a top view and FIG. 4b shows a side view of a core (without functional layer) of a shoeing according to the invention for the back foot;

FIGS. 5a, 5b and 5c show an abrasion protection strip in three views wherein FIG. 5a is from the side of the bearing surface, FIG. 5b is from behind, FIG. 5c is from the side;

FIG. 6a shows a view from the side of the bearing surface of a shoeing according to the invention for the front foot with a FIGS. 6b and 6c showing two cross-section planes, wherein FIG. 6b shows a cut plane view A-A (in enlarged 2:1 scale compared with FIG. 6a), and FIG. 6c shows a cut plane view B-B (in enlarged 2:1 scale compared with FIG. 6a);

FIG. 7 shows a half of an injection mold for the bearing-surface-side shoeing for the front foot;

FIG. 8 shows a half of an injection mold for the hoof-side shoeing for the front foot;

FIG. 9 shows an enlarged partial section from FIG. 8.

In the following, the same reference numbers stand for the same or analogous elements in the same or different figures. An additional apostrophe can denote partial sections.

To protect the hoof, shoeings are normally fixed with nails on the bearing side at the outer edge of the wing part of a hoof. Shoeings provide protection and support on the bottom, in particular for the edge of the hoof wall. The shape of a shoeing can to the greatest possible extent be identified as a U-shaped part-ring or curve, with a bearing surface on the bottom side and a contact surface on the hoof side. Optionally, a groove is inserted into the shoe at the center of the bearing surface side (i.e. the bottom side), where the holes for the nails are also introduced.

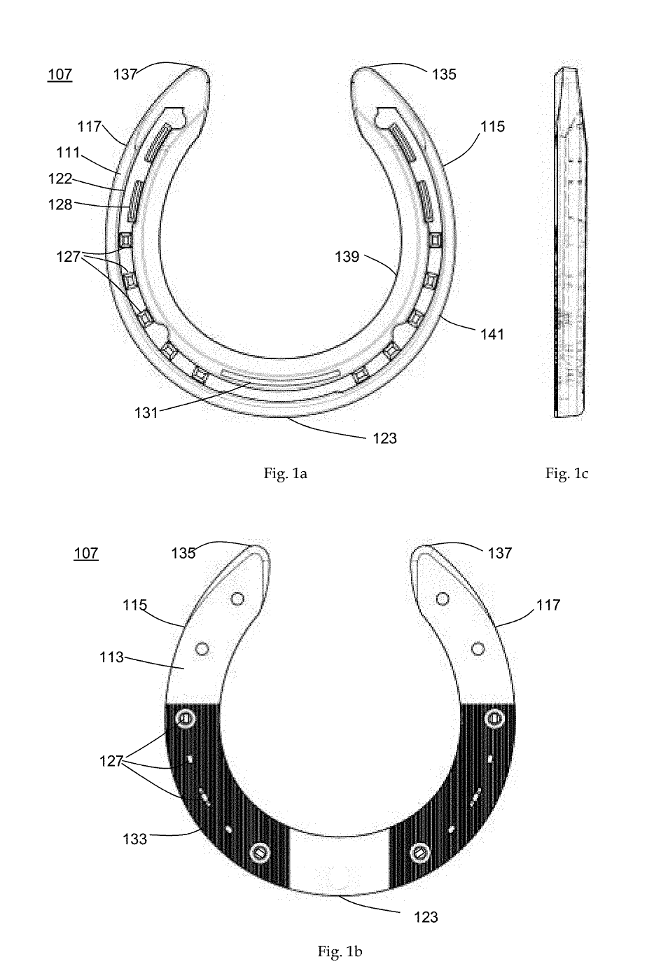

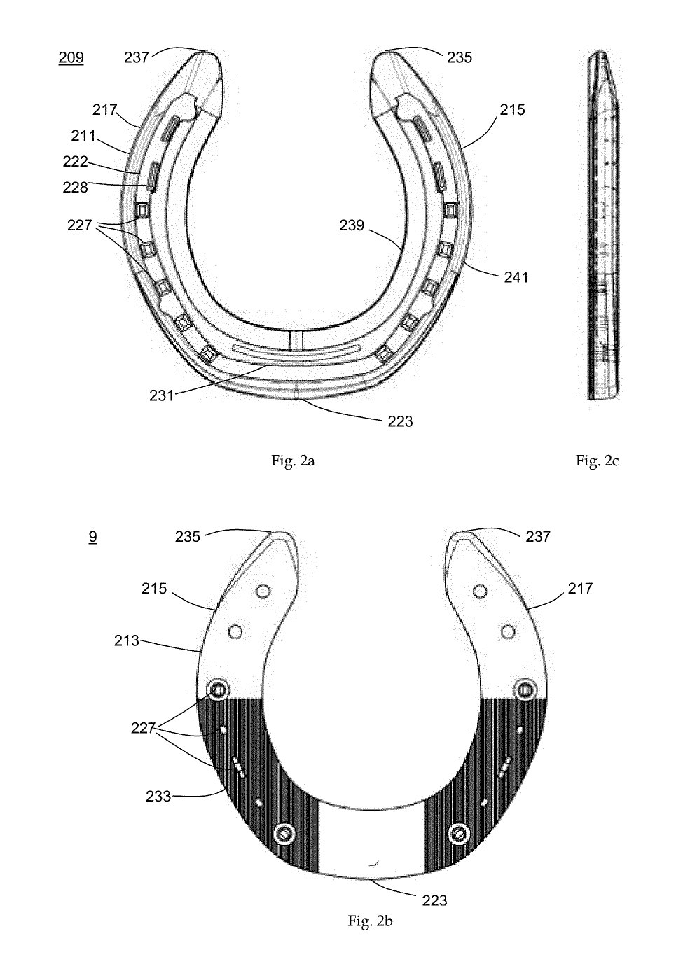

In FIGS. 1a and 1b, a shoeing 107 according to the invention for the front foot of horses is shown in two views, i.e. the bearing surface (i.e. bottom side) 111 (FIG. 1a) and the hoof side 113 (FIG. 1b). In FIGS. 2a and 2b, a shoeing 207 according to the invention for the back foot of horses is shown in two views, i.e. the bearing surface (i.e. bottom side) 211 (FIG. 2a) and the hoof side 213 (FIG. 2b). A typical shoeing 107, 207 is bent substantially U-shaped. The typical shoeing 107 or 207 thus has a central region 123, 223 (also called front region) as well as two lateral side pieces 115, 117, 215, 217 (respectively right-hand and left-hand side piece) running out towards the rear from the central or front region. The side pieces are spaced apart from one another but usually run towards one another, and each have a free end 135, 137 and 235, 237. The central region 123, 223 of the horse's hoof, which marks the position of the point of the toe (via which the horse can essentially push off while running), points in forward direction or in the running direction, while the free ends of the side pieces 135, 137, 235, 237 point outwards, substantially backwards or opposite the direction of running, from the point of the toe. According to the anatomical shape of the hoof, the shoeing 107 for the front foot can be designed to be rounder than the shoeing 207 for the back foot which is shaped to be longer in comparison. Shoeings are fixed to the sole at the edge of the hoof wall. Shoeings are expediently provided in different sizes, with the result that, depending on the size of the horse's hoof, a correspondingly fitting or shaped shoeing can be chosen. If the shoeing can be deformed, e.g. because it is made from thermoplastic which is deformable at an increased temperature, then the shape of the shoe can be individually adapted to the hoof, whereby a more accurate fit can be achieved.

On the bearing surface side, shoeings 107, 207 have essentially a more or less flat U-shaped surface 111, 211 which is designed to be fixed to the hoof conventionally with a plurality of continuous four-cornered nail holes 127, 227, which are distributed to the left and right on the bearing surface on the respective two side pieces 115 and 117 or 215 and 217 and arrayed along same. In the example of FIGS. 1a and 2a shown here, respectively 10 nail holes are distributed, with 5 nail holes shown on each side piece.

The edges of the nail holes 127, 227 are broken on the bottom side, with the result that the nail heads can be driven in as flush as possible at the level of the bearing surface. Optionally, a groove (or furrow) 122, 222 can run in the center of the bearing surface longitudinally oriented to the side piece, wherein the nail holes are arranged within the groove or furrow 122, 222. The groove or furrow 122, 222 also increases the grip and reduces the weight of the shoeing.

The nail holes 127, 227 can likewise be seen on the hoof side as these pass from the bearing surface 111, 211 to the hoof side 113, 213 through the shoeing.

As an alternative to the nails, the shoeing can also be attached by adhesion. On the hoof side, the surface 113, 213 of the shoeing 107, 207 can be abraded or textured. Due to the enlarged surface in an abraded or textured surface region 133, 233, the adhesion between hoof and shoeing is particularly good upon application of adhesive. For this purpose, at least the hoof-side surface 113, 213 of the shoeing can be abraded or textured in the region 133, 233 of the nail holes 127, 227.

In order to achieve as low a weight of the shoeing as possible the shoeing can be provided with recesses 128, 228. These material recesses are advantageously arranged behind the nail holes on the rear side piece.

On the hoof side, some of the nail holes can be designed to be round; this is contingent on production and is realized later on.

In the front shoeing region or in the region of the point of the toe 123, 223, an insert 131, 231 is embedded on the bottom side in the shoeing 107, 207 for the purpose of wear protection, in particular for the purpose of abrasion protection, here also called abrasion protection or abrasion protection insert. This is expediently made from a particularly wear-resistant material such as metal, in particular steel, e.g. tool steel. The abrasion protection insert 131, 231 is present advantageously as a curved strip, which is arranged parallel to the furrow 122, 222 and thus substantially perpendicular to the running direction. In the example shown here (FIGS. 2a and 2b), the abrasion protection insert 131, 231 is arranged behind the furrow 122, 222 in respect of the running direction. The abrasion protection reduces the friction of the functional layer, which in particular increases the wear of the shoe.

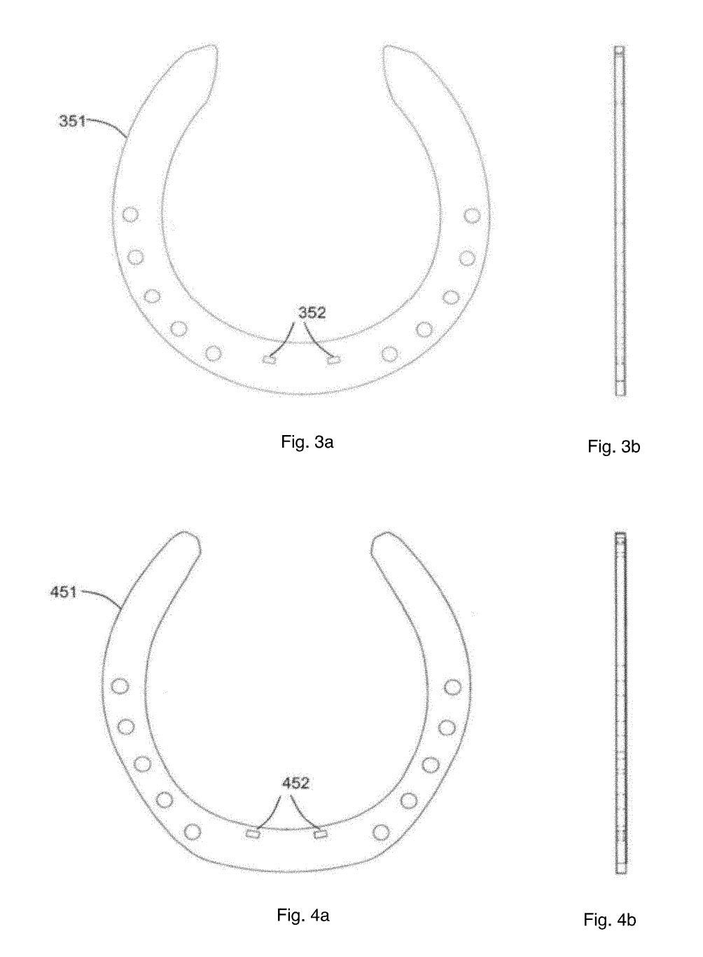

The shoeing 107, 207 has a core 351, 451. A typical core for a front foot shoeing or a back foot shoeing is shown in top view and side view in FIG. 3a and FIG. 3b or FIG. 4a and FIG. 4b. Due to the choice of material, the core 351, 451 provides the shoeing 107, 207 with the desired rigidity and stability. However, similar to the finished shoeing 107, 207, the form of the core 351, 451 for a typical shoeing 107, 207 is smaller in its spatial extent. The form of the core 351, 451 is in particular U-shaped, and thus has a central front toe region and two lateral side pieces pointing backwards from the central toe region. Holes 355, 455 for nails are advantageously created in the core 351, 451. These holes 355, 455 are preferably designed larger than the nail holes to be made in the finished shoeing. There are also present holes 352, 452 (preferably at least two e.g. rectangular holes) suitable for inserting an abrasion protection 131 in the front region of the core.

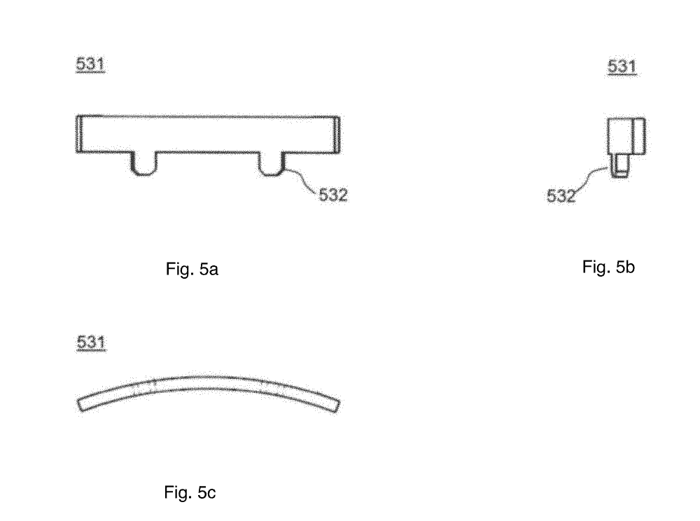

An exemplary abrasion protection 531 is shown in three views in FIGS. 5a, 5b and 5c. Here it is a strip, made of tool steel, with one, two or more straightened plug-like continuations 532. The strip is designed curved, in particular bent about an axis parallel to the alignment of the continuations. The curvature is expediently similar to the curvature of the shoeing 107 in the toe region. To produce an abrasion protection, this can be cut out from a plate, e.g. lasered out. The edges of the cut-out part are preferably sandblasted in order to break the edges.

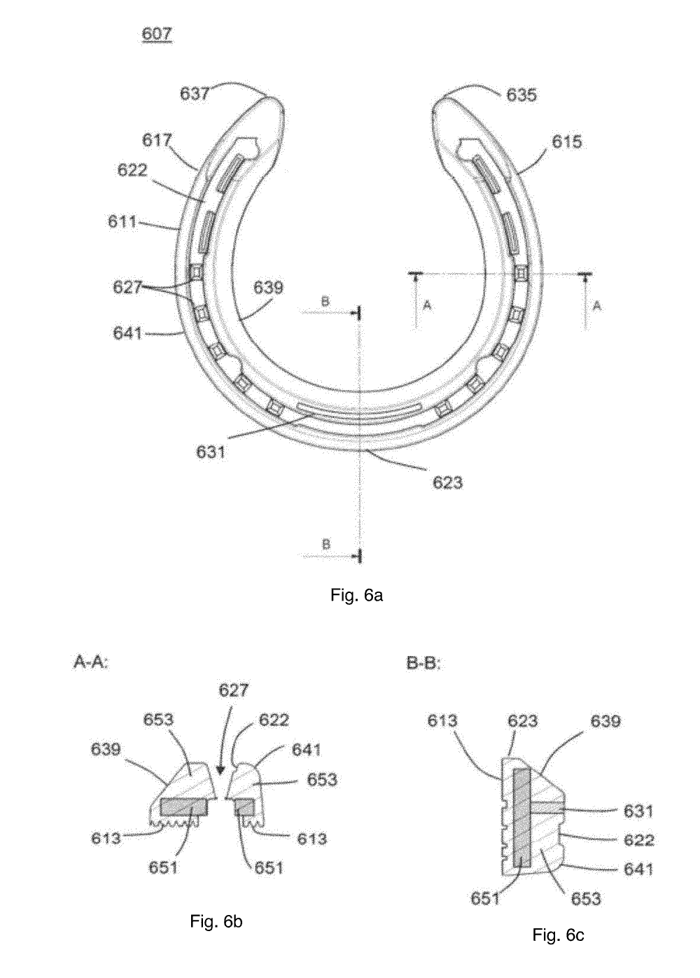

The core 351, 451 is substantially surrounded by a functional layer 653. In FIGS. 6b and 6c with reference to FIG. 6a, two cross-section drawings, A-A and B-B of different regions of a front foot shoeing 607 are shown. Cross-section drawing A-A shows a cross-section over a nail hole 627 on the right-hand side piece 615 of the shoeing 607. Cross-section drawing B-B shows a cross-section in the front region or in the toe region of the shoeing 607.

On the outside of the shoeing, the edge 641 of the shoeing 607 is broken or rounded on the bottom side or the bearing side and forms a slight rounding 641. This is favorable for the unhindered forward movement of the horse, as a result of which the hoof remains on the ground less, i.e. the risk of stumbling is reduced, but simultaneously the foothold remains very sure when pushing off. The bottom-side inner edge 639 is clearly more strongly tapered in comparison with the bottom-side outer edge 641 of the shoeing or the edge is substantially milled and instead forms an inclined surface which, when in contact with the ground, recoils from the ground, proceeding from the bottom side 611 of the shoeing. Moreover, the bottom-side inner and outer edges on the side piece ends 635, 637 are conventionally likewise clearly tapered. As a result, the hoof can more easily be released from the ground, or it experiences low resistance after coming into contact with the ground.

In each of the cross-sections A-A and B-B, the shoeing core 651 and functional layer 653 surrounding them are shown. In FIG. 2a, the cross-section proceeds away from the four-cornered nail hole 627. Parts of the core 651 and parts of the functional layer 653 are shown to the left and right of the nail hole 627. The nail hole is made in the furrow 622. On the bearing-surface side (i.e. bottom side) the functional layer 653 expediently has a greater layer thickness than on the hoof side (i.e. sole-side). The bearing-surface side (i.e. bottom side) functional layer is thicker than the hoof-side functional layer by a multiple. Starting from the core 651, the layer thickness of the hoof-side functional layer is less than 2 mm, or less than 1 mm. Starting from the core 651, the layer thickness of the bottom side functional layer is preferably greater than 2 mm, greater than 3 mm or greater than 4 mm. On the bearing-surface side, the functional layer thickness corresponds approximately to the core thickness or is greater than the core thickness. The thickness of the core 651 can lie e.g. in the range of from 3 to 8 mm. The thickness of the bearing-surface side functional layer can lie e.g. in the range of from 3 to 8 mm. The thickness of the shoeing itself lies e.g. in the range of from 6 to 16 mm or in the range of from 9 to 12 mm. The hoof side (or sole side) 613 of the shoe can be textured.

An abrasion protection 631 is embedded in the functional layer 653. Advantageously, an abrasion protection insert 631 is embedded at least in the toe region 623 of the shoeing. Abrasion protection 631 and core 651 are expediently connected to one another, for example by the abrasion protection 631—at at least two points—being inserted into the core 651. As a result, the structure of core, functional layer and abrasion protection is as stable as possible. The abrasion protection insert 631 fixed in the core can additionally have a stabilizing effect on the connection between core 651 and functional layer 653—this can be important above all in the toe region 623, where substantial shearing forces can act between core and functional layer.

For reasons of weight, the shoeing is produced from plastic or plastic fiber composite. In order to obtain particularly good mechanical properties paired with good grip properties, and further paired with good cushioning properties, a composite of long-fiber-reinforced or continuous-fiber-reinforced thermoplastic material is proposed for the core (e.g. carbon fibers and/or glass fibers in a thermoplastic matrix, in particular e.g. in a polycarbonate matrix) and a thermoplastic material or alternatively a short-fiber-reinforced thermoplastic material is proposed for the functional layer (e.g. polycarbonate with or without glass-fiber reinforcement). The shoeing according to the invention thus comprises a fiber-reinforced thermoplastic core and of a functional layer made of thermoplastic with or without fiber reinforcement. Expediently, the fiber reinforcement of the core contains long fibers or continuous fibers, i.e. e.g. fibers with a length of 20 mm or more, or 50 mm or more. The fiber reinforcement of the functional layer contains expediently short fibers, i.e. e.g. fibers with a length of less than 20 mm, less than 10 mm, or with a length in the range of from 0.1 to 1 mm.

Because of the fiber-reinforced thermoplastic material used for the core, the core is durable, rigid and simultaneously light. Thus in particular the shoeing according to the invention is light in comparison with conventional shoeings made of metal, such as iron or aluminum. In comparison with known shoeings with a fiber-reinforced thermoset material core, the present core made from fiber-reinforced thermoplastic material is particularly advantageous, as it has little or no fracture susceptibility and can be shaped even at increased temperatures, which enables a better shape adaptation to the individual horse's hoof. The thermoplastic functional-layer material is selected because of its advantageous abrasiveness and simultaneously good adhesive properties to the core material, in particular there should not be any separation between core and functional layer over a period of at least 4 or 5 weeks and, during normal use (i.e. on a shod hoof) or usual training operation during this period, the friction should at no point lead to substantial damage or changes in shape of the shoeing. If the same thermoplastic material is chosen for the matrix of the core and the functional layer, then the result is a particularly good adhesive effect between the core and the functional layer.

Formation of hollows or recesses in the shoeing, in particular in the functional layer, can further reduce weight. In particular the low weight, a specific cushioning effect and a less restricted blood supply to the hoof, in comparison with conventional shoeings, are some of the advantages of the plastic shoe per se. Further advantages of the plastic shoe according to the invention compared with known plastic shoeings which are worn in particular by racehorses are a reduced sinking depth, higher grip and reduced wear and tear. A further advantage is the good individual adaptability or moldability of the thermoplastic shoeing, in particular e.g. by individual deforming (e.g. expanding or narrowing) of each individual shoe before shoeing.

The design for front and rear hoof described in the Figures guarantees an optimal grip, reduces sinking depth and dirt absorption, which likewise leads to energy conservation.

A production method for the shoeing is demonstrated below.

The shoeing is produced by means of thermoplastic injection molding methods. The core can be produced by cutting, in particular by water jet cutting, from a plate of thermoplastic fiber composite. The material of the functional layer will advantageously be applied to the core to shape the shoeing mold via an extruder or injection molding system.

For this a core 351, 451 and optionally an abrasion protection 631 is inserted into an injection molding tool and extrusion-coated with functional layer material. There is used as core material a fiber-reinforced-thermoplastic, e.g. a carbon fiber thermoplastic composite, a glass fiber thermoplastic composite or a glass fiber/carbon fiber composite, in particular e.g. a carbon fiber polycarbonate composite, a glass fiber polycarbonate composite or a glass fiber/carbon fiber polycarbonate composite. The fibers contained in the composite material of the core are long fibers or continuous fibers. The processed functional layer material is likewise a thermoplastic, such as a fiber-reinforced thermoplastic. Particularly, a polycarbonate reinforced with glass fiber, optionally other fibers, such as e.g. carbon fibers, can be used. Particularly advantageous are glass fibers, in particular a polycarbonate with 30 weight percent glass fiber (PC-GF30). Expediently, the fibers of the functional later material are short fibers. Optionally, the functional layer material can be pre-dried before use in injection molding. The pre-drying can be carried out in polycarbonate material, in particular in glass-fiber-reinforced polycarbonate material, e.g. at approx. 120° C. (e.g. for 2 to 8 hours). For injection molding, the functional layer material is melted on and sprayed into an injection mold under pressure. The injection mold can be pre-tempered. Polycarbonate material, in particular polycarbonate with 30 weight percent glass fiber, is melted on with a temperature of from 280° C. to 320° C. and sprayed with a specific injection pressure of from 800 bar to 1400 bar in an injection mold tempered at 80° C. to 130° C. After the cooling phase, the shoeing can be removed from the mold.

In one injection molding method, a core made from a composite of a mesh of carbon fiber and glass fiber in a matrix made of thermoplastic polycarbonate is used. This core is inserted into an injection mold. Then, a polycarbonate material with or without glass-fiber reinforcement is pre-dried at 100° C. to 120° C. Thereafter, the pre-dried polycarbonate material is melted on with a temperature of from 280° C. to 320° C. and injected with a specific injection pressure of from 800 bar to 1400 bar into an injection mold tempered at 80° C. to 120° C. After the cooling phase, the shoeing is removed from the mold.

A core functional layer composite or the shoeing can—as stated above—be produced, by the functional layer being sprayed onto the core.

The abrasion protection may be produced from a metal, e.g. steel or tool steel. However, other materials are also suitable, insofar as these are more abrasion-resistant that the functional layer.

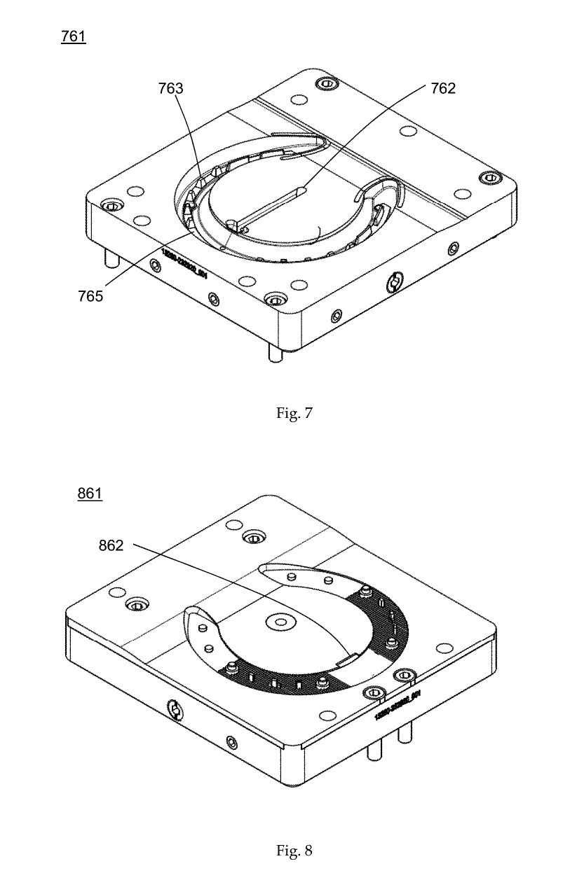

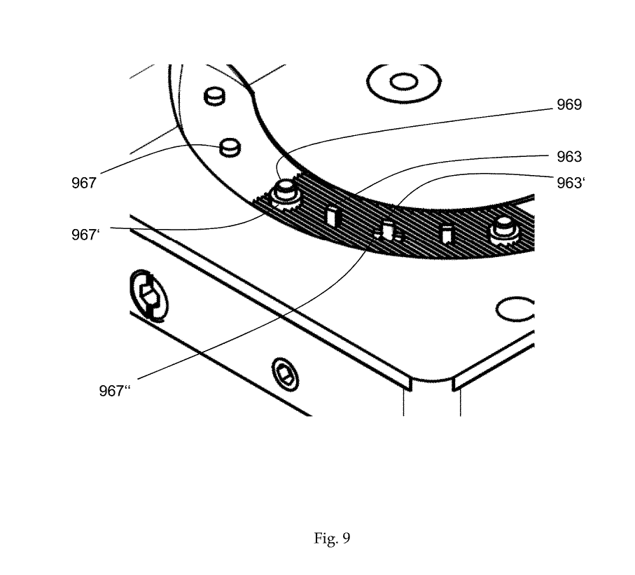

An injection mold in two matching halves for a shoeing for the front foot is shown in FIG. 7 and FIG. 8. FIG. 7 shows the half of the mold for the bearing-surface side of the shoe, while FIG. 8 shows the half of the mold for the hoof-side of the shoe. FIG. 9 also shows a partial section from FIG. 8. The mold side 761 of the bearing surface (i.e. bottom side of the shoeing) is shown in FIG. 7 and the mold side 861 of the contact side (i.e. the hoof side of the shoeing) is shown in FIG. 8.

With the injection molding method, a shoeing core (such as e.g. shown in FIG. 3) is inserted into one of the two mold sides in a predetermined position (in the present example practically into mold side 861 of the contact side), then the two mold sides 761, 861 are pushed or pressed together in custom fit, whereby an inserted core is fixed in its predetermined position. In the resultant mold cavity, the functional layer material is sprayed in. The injection mold contains at least one inlet 762, 862 for the functional layer material to be sprayed in.

The shoeing is substantially U-shaped, and is optionally provided with holes 127 for shoeing nails. Mold structures 763, 963, 963′ for shoeing nails are provided centrally in the mold halves 761, 861. In the mold side 761 of the bearing surface, the mold structures 763 for the shoeing nails are introduced together with mold structures 765 for a groove, in particular along and on the mold structures 765 of the groove.

In the mold side 861 of the bottom contact side, there are additionally designed mold structure supports 967, 967′, 967″ and mold structure pins 969 for supporting and/or positioning the core to be inserted. Because the mold structure pins 969 and the mold structures 963, 963′ for shoeing nails are extended in comparison with the mold structure supports 967, 967′, 967″, the mold structure pins 969 and the mold structures 963, 963′ for shoeing nails can penetrate through the core insert 351 at positions 355 provided therefor. The mold structure supports 967, 967′, 967″ and mold structure pins 969 serve on the one hand to separate the core to be inserted from the mold cavity wall, in order that the core can be extrusion-coated completely with the functional material, and on the other hand to fix the core in the mold cavity, in order that it is not displaced or deformed by the injection pressure occurring during injection molding.

Some of the mold structure supports 967′, 967″ are designed expediently in combination with some of the mold structures 763, 963 for the shoeing nails and/or with the mold structure pins 969 as spatially combined mold structures. This is more clearly to be seen in FIG. 9, which shows an enlarged partial section from FIG. 8.

In the present case, the protruding mold structures 763 for shoeing nails in the mold half 761 of the bearing surface form a counterpressure on the core. Alternatively, even in this mold half 761 mold structure supports could additionally be provided for the core (e.g. designed as support pins).

The invention is explained below using an example.

### EXAMPLE

Particularly good test results were produced by shoeings containing a 2-mm-thick core made of alternately coated carbon fiber and glass fiber layers embedded in a thermoplastic polycarbonate matrix, wherein this core of fiber and PC matrix material is covered with a functional layer of likewise thermoplastic polycarbonate, which advantageously is reinforced with short glass fibers. A minimum friction is thus guaranteed. The working life is over 6 weeks. The technical data of this particularly advantageous shoeing are as follows:
Core: Carbon fiber and glass fiber mesh layers in a polycarbonate matrix (in total approx. 2 mm thick)
Functional layer: Polycarbonate with short fibers made of glass
Production: 1. Hot-pressing method for producing the composite material of the core
   2. Thermoplastic injection molding method for extrusion-coating the core with functional layer material
Weight: Approx. 60 grams (size 6)
Application: Cold shoeing analogous to shoeings made of alternative material (e.g. aluminum), inc. possibility of thermoforming for individual adaptation to the respective horse's hoof
Advantages:—Very light shoeing (weight reduction of approx. 50% compared with aluminum-shoeings)
   Increased break resistance (in particular in comparison with plastic fiber composite shoeings as disclosed in patent application CH710762 (A2))
   Can be deformed or adapted to the hoof mold by means of hot deformation, e.g. at temperatures of approx. 140° C.

The shoeings according to the inventions can expediently be obtained in prefabricated sizes. However, the shoeings can be adapted to a specific degree by means of hot deformation to the individual hoof.

In summary, the shoeing consists of a core made of a thermoplastic fiber composite (e.g. carbon fibers and/or glass fibers in a thermoplastic polycarbonate matrix) and a functional layer, made of a thermoplastic (e.g. thermoplastic polycarbonate), surrounding the core. The functional layer can optionally be reinforced with fibers (e.g. glass fibers). The core matrix and functional layer or functional layer matrix may have the same thermoplastic. The desired production method is the injection molding method.

Whereas, above, specific embodiments have been described, it is apparent that different combinations of the embodiment possibilities which are shown can be applied, insofar as the embodiment possibilities are not mutually exclusive.

Whereas the invention has been described above with reference to specific embodiments, it is apparent that changes, modifications, variations and combinations can be made without deviating from the inventive concept.

1-22. (canceled)

23. A shoeing for horses, comprising:
a core made of fiber-reinforced thermoplastic polymer; and
a functional layer made of a plastic comprising thermoplastic polycarbonate or a fiber-reinforced thermoplastic polycarbonate, the functional layer surrounding the core.

24. The shoeing of claim 23, wherein the thermoplastic polymer of the core is selected from a group of polymers consisting of polycarbonates.

25. The shoeing of claim 23, wherein fibers of the fiber-reinforced thermoplastic polymer of the core are selected from a group consisting of carbon fibers, glass fibers, polymer fibers or combinations thereof.

26. The shoeing of claim 23, wherein fibers of the fiber-reinforced thermoplastic polymer of the core comprises long fibers or continuous fibers.

27. The shoeing of claim 23, wherein fibers of the fiber-reinforced thermoplastic polymer of the core are arranged in one or more layers, wherein the fibers of each layer form a mesh.

28. The shoeing of claim 23, wherein the core comprises a plurality of fiber layers laid one on top of the other, wherein one or more of the plurality of fiber layers are comprised of carbon fibers combined with one or more layers of glass fibers.

29. The shoeing of claim 23, wherein the plastic for the functional layer is fiber-reinforced.

30. The shoeing of claim 29, wherein fibers of the functional layer comprises short fibers.

31. The shoeing of claim 23, wherein the plastic for the functional layer is selected from the group consisting of fiber-reinforced polycarbonate comprising a 10 wt.-% to 50 wt.-% fiber-reinforced polycarbonate.

32. The shoeing of claim 23, wherein a plate of plastic fiber composite is added to the core.

33. The shoeing of claim 23, wherein an abrasion protection is integrated into the shoeing, which abrasion protection is comprised of a material which is more abrasion-resistant than the functional layer.

34. A method for producing a shoeing, comprising:
inserting a core made of fiber-reinforced thermoplastic polymer material into a mold; and
surrounding the core with a functional layer made of a thermoplastic polycarbonate.

35. The method of claim 34, wherein the core is surrounded with the functional layer by injection molding.

36. The method of claim 34, wherein the functional layer material is melted on at a temperature of from 260° C. to 340° C.

37. The method of claim 34, wherein the functional layer material is sprayed into the mold with a specific injection pressure of from 800 bar to 1400 bar.

38. The method of claim 34, wherein the mold is tempered at 80° C. to 130° C. before the melted functional layer material is injected.

39. The method of claim 34, wherein the functional layer material is pre-dried before being melted on at 100° C. to 130°.

40. The method of claim 34, wherein the mold is equipped with support structures to support the plastic fiber composite core so as to be spaced apart from a mold surface when positioned within the mold.

41. The method of claim 40, wherein the plastic fiber composite core is equipped with an abrasion protection that serves as a further support structure for the plastic fiber composite core in the mold and, together with the plastic fiber composite core, is substantially surrounded by the melted-on polymer material and is thereby integrated in the shoeing.

42. The method of claim 34, wherein after surrounding the core, the shoeing is cooled for curing, and after curing, the curvature of the shoeing is adjusted to a predetermined fit by mechanical deforming at temperature above room temperature in a range of from 120° C. to 160° C.

43. A method for shoeing a horse's hoof, comprising:
using a shoeing for horses, comprising:
a core made of fiber-reinforced thermoplastic polymer; and
a functional layer made of a plastic comprising thermoplastic polycarbonate or a fiber-reinforced thermoplastic polycarbonate, the functional layer surrounding the core;
adjusting the shoeing at an increased temperature in the range of from 120° C. to 160° C. to a shape of a hoof of a horse to be shod by mechanical deforming.

44. The method of claim 43, wherein the adjusting by mechanical deforming is performed by pushing or pulling the shoeing.
